(19) United States
(12) Patent Application Publication
(10) Pub. No.: US 2019/0315089 A1
(43) Pub. Date: Oct. 17, 2019

(54) NONWOVEN COMPOSITE INCLUDING COTTON FIBER WEB LAYER AND METHOD OF FORMING THE SAME

(71) Applicant: NUTEK DISPOSABLES, INC., McElhattan, PA (US)

(72) Inventors: Karthik Ramaratnam, Anderson, SC (US); Peter Zajaczkowski, Greenville, SC (US); John C. Parsons, Dallas, TX (US)

(21) Appl. No.: 15/952,901

(22) Filed: Apr. 13, 2018

(51) Int. Cl. B32B 5/06; B32B 5/26; B32B 5/02; B32B 37/18

(52) U.S. Cl. CPC B32B 5/06; B32B 5/26; B32B 5/022; B32B 37/18; B32B 2307/718; B32B 2262/0253; B32B 2262/062; B32B 2250/02; B32B 2262/0276

(57) ABSTRACT

A composite structure including at least one natural fiber web layer and at least one nonwoven web layer. In an exemplary embodiment, the natural fiber web layer is made of cotton fibers and the nonwoven web layer is a spunmelt layer. The composite structure may be used to form components of an absorbent article, such as top sheets or back sheets of a diaper.

### FIELD OF THE INVENTION

The present disclosure generally relates to composite structures, and in particular to nonwoven composite structures intended for use in absorbent articles.

### BACKGROUND

Nonwoven composite webs made with a combination of various natural fibers and synthetic fibers are known in the conventional art for use in mainly absorbent (hydrophilic) products or product components. Synthetic fibers and wood fiber combination is prevalent in wipes, while use of natural fibers such as bagasse, kenaf, hemp and ramie combined with synthetic fibers is known to be used in automotive nonwoven composite materials. Cotton in particular is a common fiber that has a widespread use in the textile industry with some limited use in wipes and absorbent products such as absorbent pads and acquisition distribution layers in a diaper. This is mainly due to the fiber's superior softness properties and its hydrophilic characteristics. Despite the superior softness and absorbent characteristics of cotton fiber, the high water wetting (hydrophilic) properties of cotton fiber limits its use in producing a hydrophobic diaper backsheet and/or a topsheet with limited hydrophilicity. Additionally, cotton containing non-woven fabrics are carded spunlaced materials and therefore have less strength compared to conventional spunmelt fabrics.

Therefore the use of natural fiber such as cotton is limited in diaper applications for both topsheet and backsheet, due to the lower overall fabric strength and sub-optimal abrasion resistance properties compared to conventional spunmelt fabrics. In addition to cotton, other natural fibers such as wood fibers and plant fibers find limited use in diaper topsheets and backsheets.

### SUMMARY OF THE INVENTION

An object of the present invention is to provide a topsheet/backsheet that contains natural fiber, more specifically a topsheet/backsheet containing cotton fiber with superior strength, abrasion resistance, tactile feel, and wettability characteristics (hydrophilic/phobic) that can be controlled based on end-use.

Another object of the present invention is to allow for the incorporation of natural fibers at low basis weight (e.g., 7 to 50 gsm), into a composite material with the total basis weight ranging from 25 to 100 gsm and having superior strength properties as compared to conventional carded materials.

Another object of the present invention is to provide a wipe product made of a combination of a natural fiber web and spunmelt webs.

A composite fabric according to an exemplary embodiment of the present invention comprises: a polypropylene spunmelt medium bonded nonwoven web, the nonwoven fabric having a basis weight of 8 gsm to 40 gsm; and a carded nonwoven web comprising 40 wt % to 70 wt % staple polyester fibers, 5 wt % to 50 wt % hydrophobic cotton fibers and 5 wt % to 50 wt % polyethylene-polypropylene bicomponent fibers, the carded nonwoven web having a basis weight of 7 gsm to 50 gsm, the nonwoven web being bonded with the carded nonwoven web by hydroentanglement.

In an exemplary embodiment, wherein the spunmelt nonwoven web comprises a slip additive in an amount of 0.1 wt % to 2 wt %.

In an exemplary embodiment, the composite fabric contains cotton in an amount of at least 5 wt %.

In an exemplary embodiment, the composite fabric contains spunmelt fiber in an amount of 20 wt % to 80 wt %.

In an exemplary embodiment, the composite fabric contains polyethylene-polypropylene bicomponent fibers in an amount of at least 5 wt %.

In an exemplary embodiment, the composite fabric contains polyester fiber in an amount of at least 20 wt %.

In an exemplary embodiment, the composite fabric has a basis weight within the range of 25 gsm to 32 gsm.

In an exemplary embodiment, the composite fabric has a roughness with a skew value (Ssk) that is less than zero as measured using a Keyence VR-3000 G2 3D microscope.

In an exemplary embodiment, the composite fabric has an air permeability greater than 400 cfm.

In an exemplary embodiment, the composite fabric has a thickness within the range of 0.25 mm to 0.60 mm.

In an exemplary embodiment, the composite fabric has a machine direction tensile strength greater than 5.5 N/cm.

In an exemplary embodiment, the composite fabric has a cross direction tensile strength greater than 1.5 N/cm.

In an exemplary embodiment, the composite fabric has a cross direction elongation greater than 80%.

In an exemplary embodiment, the composite fabric has a geometric mean tensile strength greater than 3.1 N/cm.

In an exemplary embodiment, the composite fabric has an abrasion rating greater than 3.0 as measured in accordance with ASTM D 4966-98 standard.

In an exemplary embodiment, the composite fabric has a machine direction Handle-O-Meter (HOM) stiffness within the range of 5.0 grams to 12.0 grams.

In an exemplary embodiment, the composite fabric has a cross direction Handle-O-Meter (HOM) stiffness within the range of 1.0 grams to 5.0 grams.

In an exemplary embodiment, the composite fabric has a two-sidedness with a Fuzz on Edge (FOE) differential value of 0.2 or greater.

A method of forming a composite fabric according to an exemplary embodiment of the present invention comprises: forming a polypropylene spunmelt medium bonded nonwoven web, the nonwoven fabric having a basis weight of 8 gsm to 40 gsm; forming a carded nonwoven web comprising 40 wt % to 70 wt % staple polyester fibers, 5 wt % to 50 wt % hydrophobic cotton fibers and 5 wt % to 50 wt % polyethylene-polypropylene bicomponent fibers, the carded nonwoven web having a basis weight of 7 gsm to 50 gsm; and hydroentangling the nonwoven web with the carded nonwoven web.

In an exemplary embodiment, the hydroentangling step comprises a plurality of hydroentangling steps.

In an exemplary embodiment, the plurality of hydroentangling steps comprise at least two water injection steps.

In an exemplary embodiment, the plurality of hydroentangling steps comprise: a first water injection step of exposing the webs to a plurality of water jets at a first pressure range of 40-120 bars; a second water injection step of exposing the webs to a plurality of water jets at a second pressure range of 60-150 bars; and a third water injection step of exposing the webs to a plurality of water jets at a third pressure range of 60-250 bars.

In an exemplary embodiment, the spunmelt nonwoven web is thermally bonded by an engraved roll, at a temperature range of 120 to 170° C., and a smooth roll, at a temperature range of 120 to 170° C., having a calender nip pressure range of 20 to 150 N/mm.

A composite structure according to an exemplary embodiment of the present invention comprises at least one natural fiber web layer and at least one nonwoven web layer.

According to an exemplary embodiment of the present invention, a method for making a composite structure includes: providing at least one natural fiber web layer and at least one nonwoven web layer; and hydroentangling the at least one natural fiber web layer with the at least one nonwoven web layer.

In at least one embodiment, the at least one nonwoven web layer is a spunmelt web layer.

In at least one embodiment, the at least one nonwoven web layer, which is a spunmelt web layer has a philic in-melt additive.

In at least one embodiment, the at least one nonwoven web layer comprises polypropylene, polyethylene, polyester, nylon or PLA.

In at least one embodiment, the at least one natural fiber web layer has adjustable wettability characteristics.

In at least one embodiment, the at least one natural fiber web layer is completely hydrophobic.

In at least one embodiment, the at least one natural fiber web layer is completely hydrophilic.

In at least one embodiment, the at least one natural fiber web layer is adjusted to be at least partially hydrophobic.

In at least one embodiment, the at least one natural fiber web layer comprises at least one of abaca, coir, cotton, flax, hemp, jute, ramie, sisal, alpaca wool, angora wool, camel hair, cashmere, mohair, silk, wool, hardwood, softwood, or elephant grass fibers.

In at least one embodiment, the at least one natural fiber web layer comprises cotton fibers and/or cotton linters.

In at least one embodiment, the overall cotton content of the composite product may contain up to 80%, more preferably in the 4 to 55% range.

In at least one embodiment, the at least one natural fiber web layer comprises pulp fibers, hardwood and/or softwood fibers.

In at least one embodiment, the at least one natural fiber web layer may be a preformed web in the form of a rolled good that is unwound on the composite web line to make the composite product.

In at least one embodiment, the at least one natural fiber web layer present in the form of a rolled good may be made up of 100% wood fibers.

In at least one embodiment, the at least one natural fiber web layer present in the form of a rolled good may be made up of 100% cotton fibers, more specifically cotton linters.

In at least one embodiment, the at least one natural fiber web layer present in the form of a rolled good may be made up of a combination of wood fibers and cotton fibers, more specifically cotton linters. Wood fiber content may vary from 0 to 100%, and cotton fiber content may vary from 0 to 100%.

In at least one embodiment, the at least one natural fiber web layer present in the form of a rolled good may be made up of a combination of wood fibers and hemp fibers. Wood fiber content may vary from 0 to 100% and hemp fiber content may vary from 0 to 100%.

In at least one embodiment, the at least one natural fiber web layer comprises a blend of natural fibers and synthetic staple fibers. The natural fiber content in this natural fiber web layer may be in the range of 5 to 100%, more preferably from 5 to 80%. The synthetic staple fiber content in this natural fiber web layer may be in the range of 5 to 100%, more preferably from 5 to 80%. Synthetic staple fiber may comprise at least one or more types of synthetic fiber.

In at least one embodiment, the at least one natural fiber web layer and the at least one nonwoven web layer are subjected to a hydroentangling process to form the composite structure.

In at least one embodiment, the composite web may be plain, patterned or aperture. The patterning or aperturing process is performed using the hydroentangling process.

In at least one embodiment, fluid pressure used in the hydroentangling process is within a range of 10 to 200 bars, with a target hydroentangling energy flux range of 0.05 to 1 Kw-hr/kg.

In at least one embodiment, fluid pressure used in the hydroentangling process is within a range of 20 to 100 bars, with a target hydroentangling energy flux range of 0.05 to 1 Kw-hr/kg.

In at least one embodiment, the use of a hydrophilic natural fiber which is subjected to a hydroentangling process to produce a composite non-woven web may have pronounced patterned structures with higher bulk, due to the tendency of the hydrophilic natural fibers to move to the raised areas of the pattern.

In at least one embodiment, the natural fiber web is formed using an airlaid machine inline.

In at least one embodiment, the natural fiber web is formed using a carding machine inline or offline and prebonded by hydroentangling.

In at least one embodiment, the natural fiber web is a paper web formed by a paper making machine.

In at least one embodiment, the paper web is made of 100% wood pulp or a blend of natural fibers and wood pulp.

In at least one embodiment, the at least one spunmelt web layer is made using polypropylene resin with round fiber cross-section.

In at least one embodiment, the at least one spunmelt web layer is made using polypropylene resin with shaped cross-section. The shaped cross-section of the spunmelt filaments may allow for improved entrapment of the natural fibers in the composite structure.

In at least one embodiment, the at least one spunmelt web layer is made using polypropylene resin with tri-lobal cross-section. The shaped cross-section of the spunmelt filaments may allow for improved entrapment of the natural fibers in the composite structure.

In at least one embodiment the at least one spunmelt web layer is made using resin that comprises a blend of polypropylene, polypropylene-co-ethylene block copolymers and a slip aid.

In at least one embodiment, the composite structure is a patterned structure formed by the hydroentangling process or by calendering.

In at least one embodiment, the patterned structure is a three-dimensional structure.

In at least one embodiment, the three-dimensional structure is formed by an embossed steel or steel roll with patterns of greater than 1 micron depth.

In at least one embodiment, hand feel of the composite structure is enhanced by at least one of a brush roll mechanism, chemical surface peeling or the hydroentangling process.

In at least one embodiment, the composite structure comprises water based softener chemistries including but not limited to various ethylene and propylene based glycol surfactants and additives to enhance softness of the composite structure.

In at least one embodiment, the composite structure comprises water based hydrophobic additives to enhance hydrohead of the composite structure.

In at least one embodiment, the at least one nonwoven web layer comprises PLA to enhance some physical properties of the composite structure such as tensile strength or stiffness or resilience

Other features and advantages of embodiments of the invention will become readily apparent from the following detailed description and the accompanying drawings.

### DESCRIPTION OF THE DRAWINGS

FIG. 1 is a cross-sectional view of a nonwoven composite web according to an exemplary embodiment of the present invention;

FIG. 2 is a block diagram illustrating a system for making a nonwoven composite web according to an exemplary embodiment of the present invention;

FIG. 3 is a block diagram illustrating a hydroentangling process with spunmelt nonwoven web and natural fiber web according to an exemplary embodiment of the present invention; and

FIG. 4 is a block diagram illustrating a hydroentangling process with spunmelt nonwoven web and natural fiber web according to an exemplary embodiment of the present invention.

FIG. 5 is a block diagram illustrating a hydroentangling process with spunmelt nonwoven web and natural fiber web according to an exemplary embodiment of the present invention

FIG. 6 is a table of selective starting materials and process parameters for hydraulically entangling natural fiber containing composite fabrics in accordance with exemplary embodiments of the invention.

FIG. 7 is a table of results corresponding to FIG. 6.

FIGS. 8A and 8B are tables of material characteristic comparisons between existing products and between a sample resulting from a process according to an exemplary embodiment of the invention and an existing product, respectively.

FIGS. 9A and 9B are micrographs of a composite fabric that is hydraulically entangled under a set of process parameters and conditions reflected in FIG. 6 in accordance with an exemplary embodiment of the invention.

FIGS. 10A and 10B are micrographs of a composite fabrics that is hydraulically entangled under another set of process parameters and conditions reflected in FIG. 6 in accordance with an exemplary embodiment of the invention.

FIGS. 11A and 11B are micrographs of a composite fabrics that is hydraulically entangled under yet another set of process parameters and conditions reflected in FIG. 6 in accordance with an exemplary embodiment of the invention.

FIG. 12 is a block diagram illustrating a hydroentangling process with spunmelt nonwoven web and cotton fiber web according to an exemplary embodiment of the present invention.

FIG. 13A is a micrograph of a carded side of a composite web according to an exemplary embodiment of the present invention.

FIG. 13B is a micrograph of a spunmelt side of a composite web according to an exemplary embodiment of the present invention.

### DETAILED DESCRIPTION

The present invention is directed to the use of natural fibers, specifically cotton fiber with superior strength, abrasion resistance, tactile feel, and adjustable wettability characteristics for non-woven components of absorbent articles. In an exemplary embodiment, hydrophobic cotton fiber or slightly hydrophilic cotton fiber is used to produce non-woven diaper materials, such as top sheet and back sheet materials. A cotton fiber web is bonded to a spunmelt nonwoven web layer by hydroentanglement to form a composite web structure that may be used to form a top sheet or back sheet of an absorbent article, or other absorbent article components that require at least some hydrophobicity. For the purposes of the present disclosure, the term “spunmelt” is intended to encompass both spunbond and spunbond-meltblown-spunbond (SMS) structures.

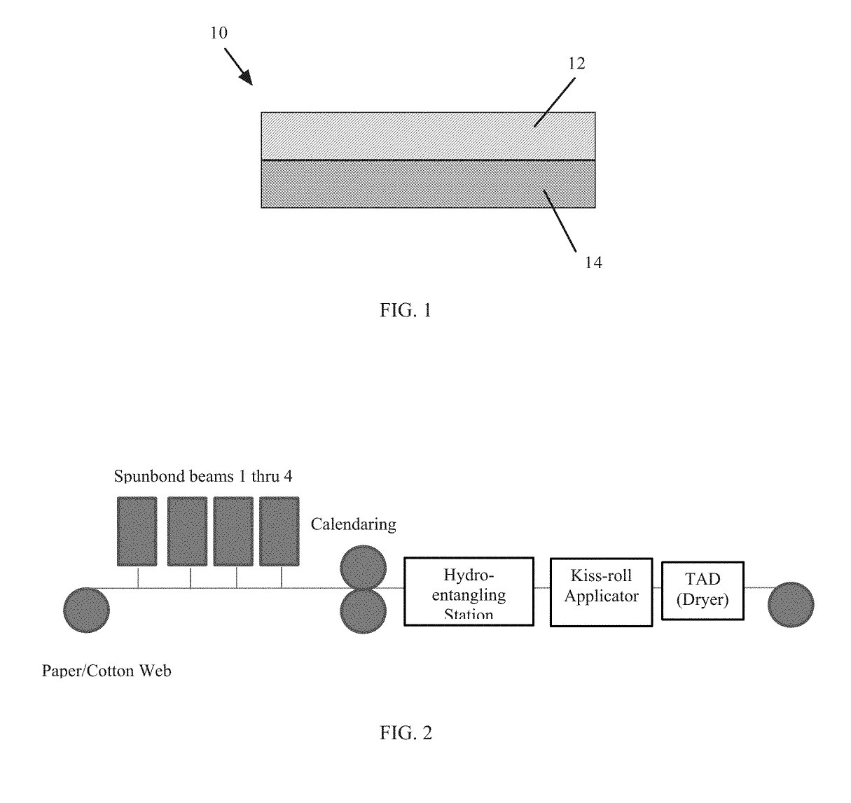

FIG. 1 is a cross sectional view of a composite web, generally designated by reference number 10, according to an exemplary embodiment of the present invention. The composite web 10 includes a natural fiber web layer 12 and a spunmelt nonwoven web layer 14.

The natural fiber web layer 12 is made of 0% to 100% processed natural fiber with hydrophobic or hydrophilic characteristics, such as, for example, abaca, coir, cotton, flax, hemp, jute, ramie, sisal, alpaca wool, angora wool, camel hair, cashmere, mohair, silk, wool, hardwood, softwood, elephant grass fibers, etc. Alternatively, the natural fiber web layer may be made of a blend of natural fibers and synthetic staple fibers. In a preferred exemplary embodiment, the natural fiber web layer 12 is made of cotton fiber. Cotton fiber is made up of cellulose, pectins, waxes and salts. Hydrophobic cotton is produced by taking controlled measures in the fiber processing step such as treating the cotton fiber with hydrophobic additives, washing the fiber to remove impurities while retaining naturally occurring wax, etc. This fiber processing step is done by the fiber manufacturer and the amount of hydrophobic additives added and level of fiber processing done to the natural fiber determines the degree of wettability characteristics. Such fibers with varied degree of wettability are available from natural fiber manufacturers. In exemplary embodiments of the present invention, such fibers are identified for use in forming a hydrophilic or hydrophobic non-woven composite web and the fiber wettability property is preserved during the hydroentangling process used to produce the composite web. In this regard, the hydrophobic characteristics of the processed natural fiber used to make the composite web 10 can be adjusted from slightly hydrophobic to fully hydrophobic.

In exemplary embodiments of the invention, the natural fiber web layer 12 may comprise a blend of natural fibers, regenerated fibers, and synthetic staple fibers. Regenerated fibers may be cellulose-based fibers that are regenerated via solvent extraction or spinning—such as, viscose rayon, modified rayon fibers such as Tencel and the like.

In a preferred exemplary embodiment, the natural fiber web layer 12 is a carded nonwoven web made up of a blend of 40 wt % to 70 wt % staple polyester fibers, 5 wt % to 50 wt % hydrophobic cotton fibers and 5 wt % to 50 wt % polyethylene-polypropylene bicomponent fibers, the carded nonwoven web having a basis weight of 7 gsm to 50 gsm. In a more specific exemplary embodiment, the carded nonwoven web comprises 30 wt % hydrophobic cotton fibers, 50 wt % staple polyester fibers and 20 wt % polyethylene-polypropylene bicomponent fibers and has a basis weight of 15 gsm.

The nonwoven web layer 14 is a spunmelt web made from thermoplastic polymers, such as, for example, polypropylene, polyethylene, polyester, nylon, PLA, etc. In a preferred exemplary embodiment, the nonwoven web layer 14 is made up of a polypropylene spunmelt nonwoven web. The polypropylene nonwoven web has a basis weight within the range of 7 gsm to 40 gsm, and in a specific exemplary embodiment has a basis weight of 13.5 gsm.

In a preferred exemplary embodiment, the composite web 10 contains cotton fiber in in an amount of at least 5 wt %, spunmelt fiber in an amount of 20 wt % to 80 wt %, polyethylene-polypropylene bicomponent fiber in an amount of at least 5 wt % and polyester fiber in an amount of at least 20 wt %. The composite fabric 10 preferably has a basis weight within the range of 25 gsm to 32 gsm. Further, the composite fabric 10 preferably has a roughness with a skew value (Ssk) that is less than zero as measured using a Keyence VR-3000 G2 3D microscope (Keyence Corporation, Osaka, Japan), indicating that height distribution of the surface roughness profile is skewed above the mean plane (i.e., there are more peaks than valleys).

The composite fabric 10 is preferably treated with a slip aid in the form of an amide, such as, for example, erucamide or oleamide.

The layers 12 and 14 of the composite web 10 are bonded together by hydro-entangling. In exemplary embodiments, the composite web 10 may include more than one natural fiber web layer and/or more than one nonwoven web layer 14.

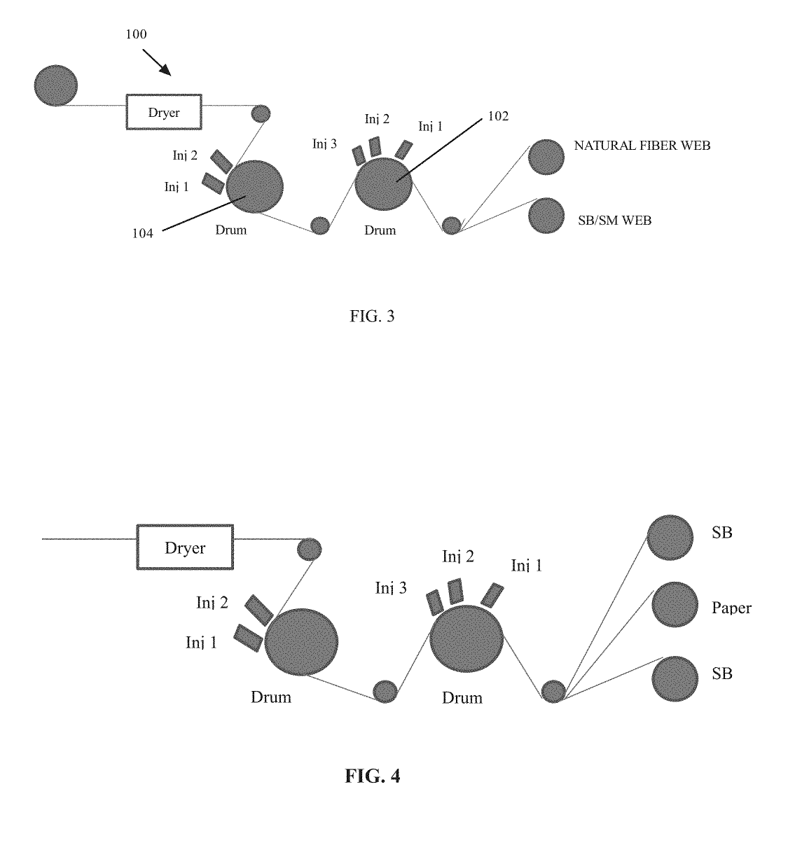

In another exemplary embodiment, the natural fiber web layer 12 is made of cotton fiber or wood pulp. Most commonly available hydrophilic cotton fibers from various fiber manufacturers can be used to make the natural fiber web. Conversely, unlike the previous embodiment, here the hydrophobic characteristic required for the composite web can be imparted post hydro-entangling at the kiss roll station via surface modification. Specifically, as shown in FIG. 2, the wet web coming out of the hydroentangling station passes through a kiss-roll applicator. At the kiss-roll applicator, several hydrophobic additives/surfactants such as wax emulsions, siloxane chemistries, fluorocarbons and other hydrocarbons can be applied to the web. The functional —OH groups present in the natural fiber web can react with the hydrophobic chemistries to form a permanent bond. This formed chemical linkage is cured at the through air drier. This method imparts durable hydrophobic properties to the composite web because the additive treatment is done post hydro-entangling step.

An additional surface finish, such as a softener can be applied to the composite web post hydro-entangling at the kiss roll station. For example, at the kiss-roll applicator, several silicone based softeners, debonders etc., can be applied to the web to impart superior tactile feel. The functional —OH groups present in the natural fiber web can react with the softener chemistries to form a permanent bond. This formed chemical linkage is cured at the through air drier.

In another exemplary embodiment, the natural fiber web layer 12 is made using a paper machine with both wood pulp and cotton linters. Hydrophobic and softness characteristics are imparted to the composite web post hydro-entangling station at the kiss roll applicator. For example, several surfactants that impart dual properties such as softness and hydrophobicity including but not limited to silicone based softeners, debonders, poly ethylene and propylene glycol based surfactants etc., can be applied to the web at the kiss roll applicator. The functional —OH groups present in the natural fiber web can react with the applied surface chemistry to form a permanent bond. This formed chemical linkage formed is cured at the through air drier.

The natural fiber web layer 12 can be produced using an airlaid machine inline, a carding machine inline or offline with prebonding via hydroentangling, or may be introduced as a paper web produced in a wetlaid machine. In the case of a paper web, the natural fiber web layer 12 may be made of 100% wood pulp, a blend of cotton and wood pulp or a blend of other natural fibers, such as hemp and wood pulp.

The spunmelt web layer 14 may be produced using standard polypropylene resin with round fiber cross-section or shaped cross-sections, such as a tri-lobal fiber. The increased surface area of the shaped fiber assists in retaining the natural fibers in the composite web during the hydroentangling process. Alternatively, the spunmelt web layer 14 is softer than a standard web and is produced by special formulations of resin including blends of polypropylene, polypropylene-co-ethylene block copolymers and a slip aid, such as erucamide.

The fluid pressure used to hydroentangle the two or more layers of the composite web 10 is within the range of 10 to 200 bars, and more preferably within the range of 20 to 100 bars. The hydroentangling energy flux target ranges between 0.05 to 1 Kw-hr/kg. The composite web 10 may be a patterned structure formed by the hydroentangling process or by calendering methods. In this regard, hydroentangling can create high density and low density natural fiber areas in the composite structure depending on the water pressure and water movement from jet to drum. The patterned structure can be a three-dimensional structure formed by the use of an embossed steel or steel roll with deep patterns greater than 1 micron depth.

In an exemplary embodiment, the composite web has a superior hand feel due to short fiber protrusions on the surface resulting from fuzzy finish. Fuzziness may be created by a brush roll mechanism, use of chemicals to create a surface peel or the hydroentangling process. To create free fibers/fuzz using the brush roll mechanism, the composite material is passed through a set of rolls that have fine bristles which produce loose fibers on the surface as it passes through. In the chemical surface peeling process, slightly alkaline or acidic solutions with the ability to swell/react with natural fibers are used to create loose fibers/fibrils on the surface. For the hydroentangling process, process conditions such as water jet pressure, choice of jet strip and/or wire mesh design on the suction boxes are adjusted to create vertical orientation of the short natural fibers. The level of fuzz is quantifiable using surface analysis tools such as optical microscope with surface topography measurement capabilities.

The composite web of the present invention has a durable and superior softness and slickness due to the natural fiber's ability to form covalent bonds with water based softener chemistries and surfactants. Use of natural fibers to make composite nonwoven material allows for further surface modification to the final web. Some specific end uses include use of water based surfactants and other chemistries to impart softness and or hydrophobicity to the product. For example, treatment of the natural fiber composite web with surfactants such as polyethylene glycol (PEG) provides a soft and slick yet durable finish, due to the covalent bond formation between natural fiber functional groups and hydroxyl groups of the PEG surfactant. Also, the strength properties of the natural fiber spunmelt composite material can be enhanced when a thermoplastic material such as PLA is used to make the spunmelt matrix. This strength increase is due to the reaction between the functional end groups in PLA and functional groups in natural fiber such as cotton, hemp, wood pulp, etc.

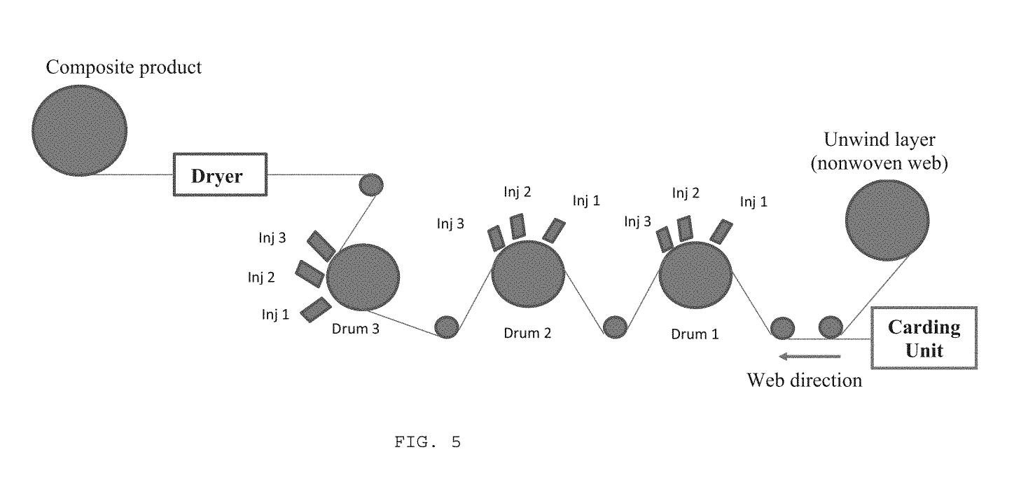

FIG. 3 shows a hydroentangling apparatus, general designated by reference number 100, according to an exemplary embodiment of the present invention. A natural fiber web and a spunmelt web are fed to the hydroentangling apparatus 100 where they are layered together and subsequently fed to drums 102 and 104. The natural fiber web is formed as a paper web prior to delivery to the hydroentangling apparatus 100 by, for example, a through air drying (TAD) machine or by an offline carding machine with prebonding. Alternatively, the natural fiber web may be formed inline using an airlaid or carding machine. As the layered structure passes over the drums 102, 104, manifolds surrounding the drums 102, 104 generate water jets so as to hydroentangle the layered structure in a multi-step hydroentangling process. The hydroentangling process results in the formation of a composite web structure made up of a natural fiber web layer and a spunmelt layer. It should be appreciated that the final product may include any number of both natural fiber web layers and spunmelt layers arranged in any sequence.

The following examples and comparative examples are illustrative of various features and advantages of the present invention.

Test methods used to determine fabric properties described in the examples were measured by the following methods.

Strike-Through Test Method

A test method that measures the rate of penetration of a 5 mL volume of 0.9% sodium chloride based saline solution (simulated urine) into a nonwoven that is placed upon five-layers of absorbent paper. Industry standard Lister strikethrough test equipment was used for this test. Hydrophilicity drives strike-through times. Lower strike-through values typically indicate a more hydrophilic material. Typical strike-through values for a nonwoven used in a diaper top-sheet are 2-3 seconds.

The test procedure includes the following steps:
1.1. Set 10 plies of Ahlstrom Grade 989 strikethrough filter paper smooth side facing upwards, on the acrylic base plate.
1.2. Place a 10 cm×10 cm sample—smooth side facing upwards—on top of the filter paper.
1.3. Set the strikethrough plate on top of the prepared samples.
1.4. Position the assembled sample and equipment on the testing base in a way that it is centered underneath the funnel.
1.5. Dispense 5 ml of sodium chloride into the funnel.
1.6. Press the start button located on the left hand side of the Lister to release liquid onto the sample.
1.7. When all of the liquid has passed through the electrodes of the strikethrough plate, the Lister timer will stop.
1.8. Record the time displayed on the Lister and report as the first strikethrough time.

Rewet Test Method

A test method that assess a nonwoven's tendency to retain the insult fluid during a strike-through test. This test is especially used on a top-sheet where the function is to rapidly pull the insult through it and allow it to transfer through the acquisition layer to the absorbent core. If a nonwoven is too absorbent, it will retain some of the insult fluid instead of allowing it to transfer to the core. This causes a high re-wet value. Typically, for a diaper topsheet application the goal is to have fast strike-through times with low re-wet values since a nonwoven with a high re-wet value will retain the insult fluid and stay wet which is not good for skin contact. The re-wet is measured by insulting the nonwoven with a larger volume of 0.9% saline solution and then placing pre-weighed paper on top of the wetted nonwoven. A weight is placed on top of the paper to simulate a baby sitting on the wet top-sheet. After a period of time the weight is removed and the paper is weighed again. Fluid that was retained in the nonwoven is pulled into the paper and its mass is recorded. Typical re-wet values are ˜0.15 g.

The test procedure includes the following steps, which is to be performed after completing the single strike through test described above.
a. Weigh 2 pieces of the wetback paper. The mass should be recorded in grams to the nearest 0.01 gram. Record this mass as “weight before”.
b. Slide the plastic tray w/ the filter paper and nonwoven specimen into the Wetback tester.
c. Push the “WET” button. (weight will lower and remain in place for 3 minutes)
d. After 3 minutes, place the 2 pieces of wetback paper directly on top of the nonwoven sample.
e. Push the “REWET” button. (weight will lower and remain in place for 2 minutes)
f. After 2 minutes, remove and weigh the 2 pieces of rewet paper. Mass should be recorded in grams to the nearest 0.01 gram. Record this mass as “weight after”.
   Note: Rewet paper should be weighed immediately after removing the baby weight. If not, the liquid will evaporate.
g. Calculate the rewet value (g): rewet=weight after −weight before

Handle-O-Meter Test Method

The Handle-O-Meter (HOM) stiffness of nonwoven materials is performed in accordance with WSP test method 90.3 with a slight modification. The quality of “hand” is considered to be the combination of resistance due to the surface friction and flexural rigidity of a sheet material. The equipment used for this test method is available from Thwing Albert Instrument Co. In this test method, a 100×100 mm sample was used for the HOM measurement and the final readings obtained were reported “as is” in grams instead of doubling the readings per the WSP test method 90.3. Average HOM was obtained by taking the average of MD and CD HOM values. Typically, lower the HOM values higher the softness and flexibility, while higher HOM values means lower softness and flexibility of the nonwoven fabric.

Tensile Strength Measurement Method

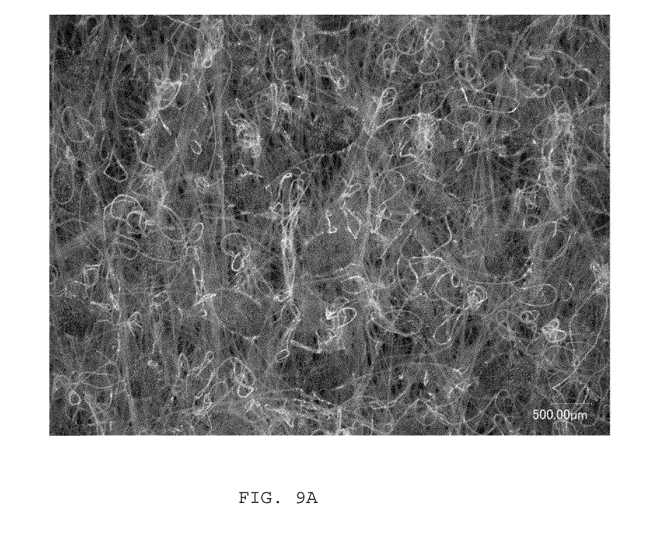

Tensile strength measurement is performed in accordance with either ASTM or WSP methods, more specifically ASTM D5035 or WSP 110.4(05)B, using an Instron test machine. Measurement is done in both MD and CD directions respectively. MD strength and elongation, CD strength and elongation, along with geometric mean tensile strength (GMT), which is the square root of the product of MD and CD strength are reported in the results table, FIG. 7.

Surface Roughness Parameters (Ssk, Sa, Etc.)

Unique areal surface texture was measured using a Keyence VR-3200 3D Macroscope equipped with motorized XY stage, VR-3000K controller, VR-H2VE version 2.2.0.89 Viewer software, VR-H2AE Analyzer software, and VR-H2J Stitching software. After following calibration procedures as outlined by Keyence equipment manual, care was taken to ensure no creases or folds were present and the sample was not under any MD or CD directional stress. 25× magnification was utilized with the following selections on the viewer software: “Expert Mode” viewer capture method, stitching set to “Auto” with the Area Specification Mode set to “Detailed” and “Start Point & Image Count” selected. A 4×4 image stitch was chosen which produced a measurement with the approximate dimensions of a 43 mm by 31 mm rectangular area. For the Measurement Settings, the Measurement Mode used the “Glare Removal” filter and the Measurement Direction was set to “Both Sides.” The Adjust Brightness for Measurement was set to “Auto” and Display the Missing & Saturated Data was turned on. Once the surface of the sample was successfully measured, the VR-H2AE Analyzer software was used characterize the surface roughness of the sample by selecting “Surface Roughness,” “Add Area,” “All Areas,” and selecting the desired surface roughness parameters provided by the software.

Other reported properties such as air permeability and thickness measurements were determined in accordance with ASTM or INDA standard test methods.

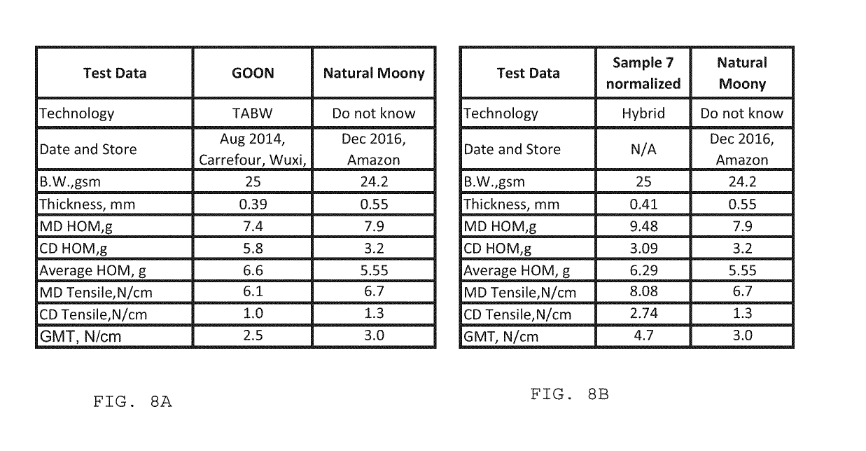

As shown in FIG. 6, the materials used for the respective trials (corresponding to respective “Sample Codes” in FIGS. 6 and 7), which include 10 gsm and 15 gsm spunmelt nonwoven fabrics bonded with low and medium bonding conditions, and hydroentangled with blended philic cotton A, pure and blended phobic cotton A, and phobic cotton B, respectively.

Low bonding conditions comprise an engraved-roll temperature of 145° C., smooth-roll temperature of 145° C. and calender pressure of 30 N/mm.

Medium bonding conditions comprise an engraved-roll temperature of 150° C., smooth-roll temperature of 150° C. and calender pressure of 30 N/mm.

In addition, as reflected in the Table of FIG. 6, the strips and screens used with the water injector sets (C1, C2, and C3) for hydraulically entangling the nonwovens are as follows:

Strip: 1R:—a metal strip perforated with one row of very small holes across its width from which the high pressure water flows creating water needles that hit the nonwoven and carded web and entangle the fibers together.

Strip: 2R:—a metal strip perforated with two rows of very small holes across its width from which the high pressure water flows creating water needles that hit the nonwoven and carded web and entangle the fibers together.

Screen—MSD: a metal sleeve that fits over the drum in the hydraulic jet-lace unit against which the hydraulic water needles are applied to the material. 100 holes/cm2 which are 300 microns in diameter. 8% open-area.

Screen—PS1: a metal sleeve with a matrix of holes which allows for the creation of a pattern into the nonwoven based on water flow through the screen—with an average hole diameter of 3 mm.

Screen—AS1: a metal sleeve with a matrix of holes which allows for the creation of a aperture hole into the nonwoven based on water flow through the screen—the average aperture size being 0.9 mm×1.5 mm, MD×CD.

The results shown in FIG. 7 relate to cotton fiber based spunmelt composite fabrics. The parameters include a resulting basis weight (BW) is gsm (grams per square meter), AirPerm (air permeability) in cfm (cubic feet per minute), thickness, MDT (machine direction tensile strength) in N/cm (Newtons per centimeter), MDE (machine direction elongation) in %, CDT (cross machine direction tensile strength) in N/cm (Newtons per centimeter), CDE (cross direction elongation) in %, GMT (Geometric mean tensile strength) in N/cm:—which is the square root of the product of MDT and CDT, MD HOM (machine direction Handle-O-Meter) in grams (g), CD HOM (cross machine direction Handle-O-Meter), Avg HOM (average Handle-O-Meter), “visual” abrasion resistance, and strike-through and rewet tests.

The “visual” abrasion rating resistance parameter refers to a NuMartindale Abrasion measure of the abrasion resistance of the surface of a fabric sample and is performed in accordance with ASTM D 4966-98, which is hereby incorporated by reference. The NuMartindale Abrasion test was performed on each sample with a Martindale Abrasion and Pilling Tester by performing 40 to 80 abrasion cycles for each sample. Testing results were reported after all abrasion cycles were completed or destruction of the test sample. Preferably, there should be no visual change to the surface of the material.

For each sample, following NuMartindale Abrasion, an abrasion rating was determined based on a visual rating scale of 1 to 5, with the scale defined as follows:

5=excellent=very low to zero fibers removed from the structure.

4=very good=low levels of fibers that may be in the form of pills or small strings.

3=fair=medium levels of fibers and large strings or multiple strings.

2=poor=high levels of loose strings that could be removed easily.

1=very poor=significant structure failure, a hole, large loose strings easily removed.

### Example 1: Method to Produce a Patterned Composite Web by Hydroentangling a Preformed Cotton Web and Spunmelt Web

A 25 gsm 50:50% cotton: staple polypropylene fiber carded web was made using a Trutzschler carded spunlace line (Trützschler GmbH & Co. KG, Mönchengladbach, Germany). HE energy levels used to pre-entangle the carded web was at 20, 30, 40 bars from the 3 injection manifolds of drum 1 and 60, 60 bars from the injection manifolds of drum 2, respectively as shown in FIG. 3. As the next step to make the composite web, a 12 gsm spunmelt polypropylene web was hydroentangled with the preformed carded web to produce a composite web using the same Trutzschler carded spunlace line. Energy levels used to hydroentangle the spunmelt and carded webs were at 20, 80, 80 bars from the 3 injection manifolds of drum 1 and 100, 100 bars from the injection manifolds of drum 2, respectively.

### Example 2: Method to Produce a Patterned Composite Web by Hydroentangling a Preformed Cotton Web and 2 Spunmelt Webs

A 25 gsm 100% cotton fiber carded web was made using a Trutzschler carded spunlace line. HE energy levels used to pre-entangle the carded web was at 20, 30, 40 bars from the 3 injection manifolds of drum 1 and 60, 60 bars from the injection manifolds of drum 2, respectively as shown in FIG. 3. As the next step to make the composite web, two identical 12 gsm spunmelt polypropylene webs were hydroentangled with the preformed carded web to produce a three layer composite web using the same Trutzschler carded spunlace line. Energy levels used to hydroentangle the spunmelt and carded webs were at 20, 80, 80 bars from the 3 injection manifolds of drum 1 and 100, 100 bars from the injection manifolds of drum 2, respectively.

### Example 3: Method to Produce a Patterned Composite Web by Hydroentangling Paper and Spunmelt Webs at Low Energy

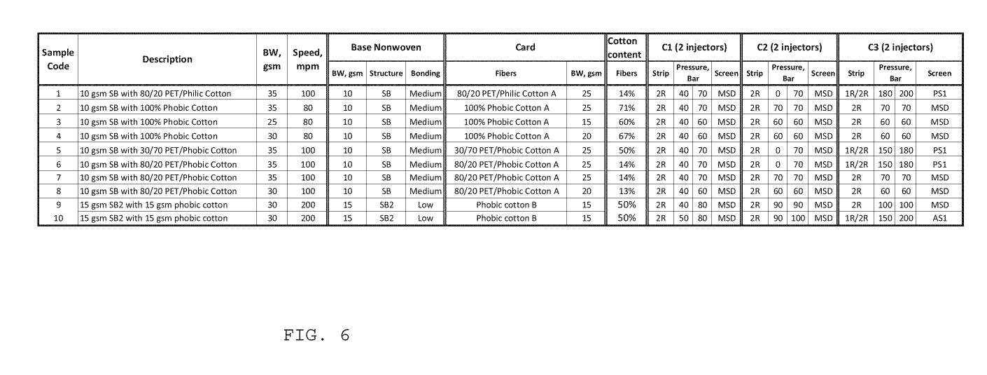

A patterned/structured paper web was made using a TAD paper machine. The paper web had permanent wet strength Kymene™ 821 (PAE resin) available from Hercules Incorporated, Wilmington, Del., USA, at add-on levels of at least 6 kg/ton. The patterned structured web was then hydroentangled with two 12 gsm polypropylene spunmelt webs. The patterned structure of the paper web was preserved in the composite non-woven fabric by using a low HE energy intensity during the hydroentangling process. HE energy conditions were 20, 40, 40 bars from the three injection manifolds of drum 1 and 40, 40 bars from the two injection manifolds of drum 2, as shown in FIG. 4.

### Example 4: Method to Produce a Flat Composite Web by Hydroentangling Paper and Spunmelt Webs at High HE Energy

Two identical spunmelt polypropylene webs with basis weight of 12 gsm each and a 20 gsm paper web used to make paper towel were hydroentangled together to make a composite non-woven fabric. FIG. 4 shows the web arrangement with the paper web sandwiched between the two spunmelt webs.

The patterned/structured paper web was made using a TAD paper machine. The paper web had permanent wet strength Kymene 821 (PAE resin) at add-on levels of at least 6 kg/ton. High HE energy levels was used to entangle the two SB and paper web at 20, 100, 100 bars from the three injection manifolds of drum 1 and 150, 150 bars from the two injection manifolds of drum 2, as shown in FIG. 4. Due to the use of high HE energy levels, the patterned paper web structure was disrupted and lost during the process resulting in flat but strong composite non-woven material.

The present invention is further described with reference to the following additional examples with a variety of natural fiber raw materials and process conditions, but it should be construed that the present invention is in no way limited to those examples.

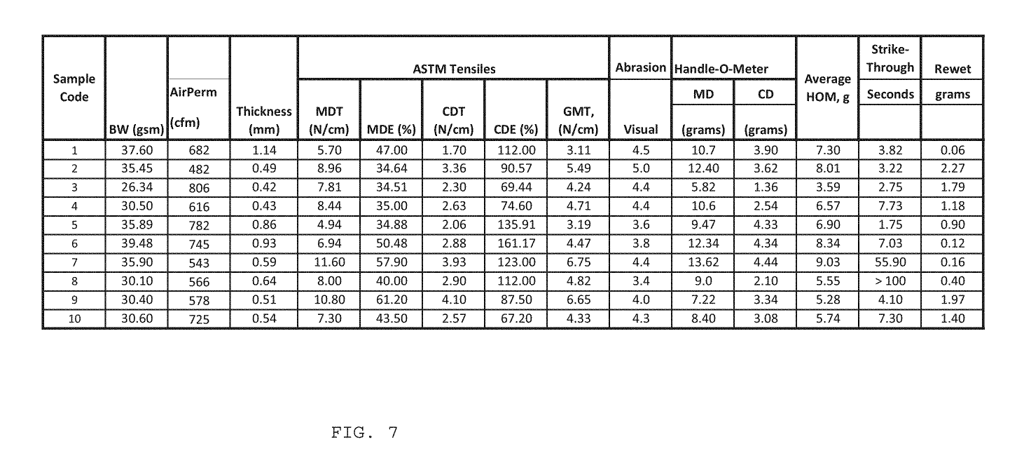

FIG. 5, for example, illustrates a hydroentangling apparatus according to another exemplary embodiment of the present invention. A natural fiber web may be formed by a carding machine (or “unit”) and a spunmelt web may be unwound before being fed to the hydroentangling apparatus where the webs are layered together and subsequently fed to drums (Drum 1, Drum 2, and Drum 3) with respective water injectors (Inj 1, Inj 2, and Inj 3). The hydroentangled web layers may then be dried to form the composite product.

### Example 5: Method to Produce a Cotton Containing Nonwoven Fabric

This Example refers to Sample #1 (“Sample Code” in FIGS. 6 and 7), wherein a 10 gsm spunmelt nonwoven was produced in a 3 beam spunmelt process, laying down three layers of fibers using ExxonMobil 3155 polypropylene. The 3 layer spunmelt was exposed to medium bonding conditions using a standard oval bond roll, with ˜18% land area. The resulting 10 gsm spunmelt web was unwound on a spunlace line as shown in FIG. 5 where it was combined with a 20 gsm carded nonwoven web containing discontinuous fibers made of 80 and 20% polyester and philic cotton fibers, respectively. The polyester fiber is a standard staple fiber with 1.5 to 2 denier per filament, 38 mm fiber length. Fiber length of philic cotton fiber A is typically in the range of 20 to 25 mm and can be purchased from several cotton suppliers. The process conditions to combine the carded and spunmelt web are shown in FIG. 6. As shown in FIG. 6, the process conditions for Sample #1 include: exposing the combined web to C1 (water) 2R injectors at 40 and 70 bars over a MSD screen, C2 2R injectors (subset) at 70 bars over a MSD screen, and C3 1R/2R injectors at 180 and 200 bars, respectively, over a PS1 screen. Additionally, a patterning sleeve PS1 was used in the 3^{rd} drum to create a patterned composite web. The resulting fabric has approximately 14% cotton content, with very good tensile strength of GMT=3.11 N/cm and excellent abrasion resistance of 4.5 visual rating as shown in FIG. 7. The excellent abrasion resistance ratings indicate very good fiber tie-down of both the cotton and polyester fiber to the base spunmelt web.

### Example 6: Method to Produce a Cotton Containing Nonwoven Fabric

This Example refers to Sample #2 (“Sample Code” in FIGS. 6 and 7), wherein a 10 gsm spunmelt nonwoven was produced in a 3 beam spunmelt process, laying down three layers of fibers using ExxonMobil 3155 polypropylene. The 3 layer spunmelt was exposed to medium bonding conditions using a standard oval bond roll, with 18% land area. The resulting 10 gsm spunmelt web was unwound on a spunlace line as shown in FIG. 5, where it was combined with a 20 gsm carded nonwoven web containing discontinuous fibers made of 100% phobic cotton fibers. Fiber length of phobic cotton fiber A is typically in the range of 20 to 25 mm and can be purchased from several cotton suppliers. The process conditions to combine the carded and spunmelt web are shown in FIG. 6. A detailed description of the process conditions for Sample #2 shown in FIG. 6 will not be repeated as they correspond to those of Sample #1 in Example 5 above but with different values for the respective parameters. The resulting fabric has approximately 71% cotton content, with excellent tensile strength of GMT=5.49 N/cm and an excellent abrasion resistance of 5 visual rating as shown in FIG. 7. The excellent abrasion resistance ratings indicate very good fiber tie-down.

### Example 7: Method to Produce a Cotton Containing Nonwoven Fabric

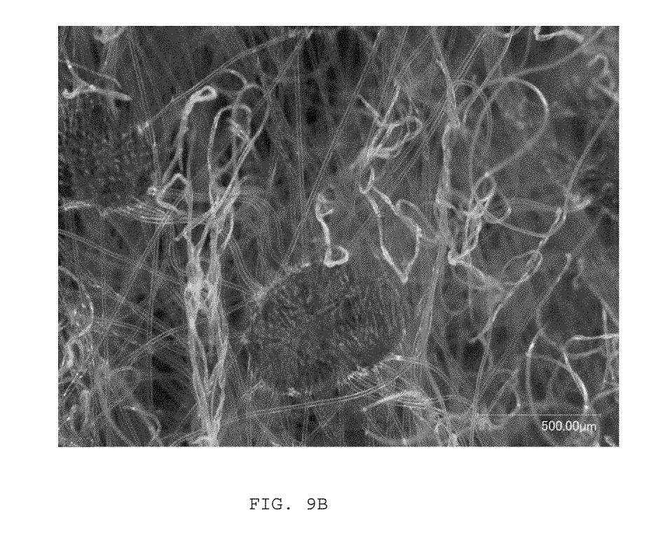

This Example refers to Sample #3, wherein a 10 gsm spunmelt nonwoven was produced in a 3 beam spunmelt process, laying down three layers of fibers using ExxonMobil 3155 polypropylene. The 3 layer spunmelt was exposed to medium bonding conditions using a standard oval bond roll, with 18% land area. The resulting 10 gsm spunmelt web was unwound on a spunlace line as shown in FIG. 5, where it was combined with a 15 gsm carded nonwoven web containing discontinuous fibers made of 100% phobic cotton fibers. Fiber length of phobic cotton fiber A is typically in the range of 20 to 25 mm and can be purchased from several cotton suppliers. The process conditions to combine the carded and spunmelt web are shown in FIG. 6. A detailed description of the process conditions for Sample #3 shown in FIG. 6 will not be repeated as they correspond to those of Sample #1 in Example 5 above but with different values for the respective parameters. The resulting fabric has approximately 60% cotton content, with very good tensile strength of GMT=4.24 N/cm and excellent abrasion resistance of 4.4 visual rating, as shown in FIG. 7. Additionally the average HOM data of 3.59 grams indicates excellent hand feel and fabric flexibility. In general, HOM is a measure of softness and lower the test value in grams, higher the softness. In this example, it is to be noted that the average HOM values obtained are even better than the competitive product HOMs shown in FIG. 8A.

### Example 8: Method to Produce a Cotton Containing Nonwoven Fabric

This Example refers to Sample #7, wherein a 10 gsm spunmelt nonwoven was produced in a 3 beam spunmelt process, laying down three layers of fibers using ExxonMobil 3155 polypropylene. The 3 layer spunmelt was exposed to medium bonding conditions using a standard oval bond roll, with 18% land area. The resulting 10 gsm spunmelt web was unwound on a spunlace line as shown in FIG. 5, where it was combined with a 25 gsm carded nonwoven web containing discontinuous fibers made of 80 and 20% polyester and phobic cotton fibers, respectively. The polyester fiber is a standard staple fiber with 1.5 to 2 denier per filament, 38 mm fiber length. Fiber length of phobic cotton fiber A is typically in the range of 20 to 25 mm and can be purchased from several cotton suppliers. The process conditions to combine the carded and spunmelt web are shown in FIG. 6. A detailed description of the process conditions for Sample #7 shown in FIG. 6 will not be repeated as they correspond to those of Sample #1 in Example 5 above but with different values for the respective parameters. The resulting fabric has approximately 14% cotton content, with very good tensile strength of GMT=6.75 N/cm and excellent abrasion resistance of 4.4 visual rating as shown in FIG. 7. The excellent abrasion resistance ratings indicate very good fiber tie-down of both the cotton and polyester fiber to the base spunmelt web.

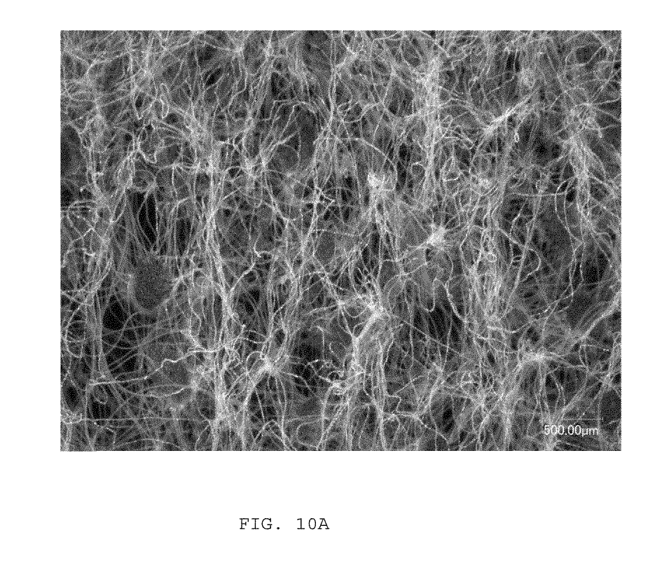

FIGS. 9A and 9B are micrographs of a Sample #7 composite fabric, FIG. 9B being a higher magnification micrograph. From these figures, it is observed that the bond pattern used in the primary nonwoven web is still intact.

### Example 9: Method to Produce a Cotton Containing Nonwoven Fabric

This Example refers to Sample #9, wherein a 15 gsm spunmelt nonwoven was produced in a 4 beam spunmelt process, laying down four layers of fibers using ExxonMobil 3155 polypropylene. The 4 layer spunmelt was exposed to low bonding conditions using a standard oval bond roll, with 18% land area. The resulting 15 gsm spunmelt web was unwound on a spunlace line as shown in FIG. 5, where it was combined with a 15 gsm carded nonwoven web containing discontinuous fibers made of 100% phobic cotton fibers. Fiber length of phobic cotton fiber B is typically in the range of 20 to 25 mm and can be purchased from several cotton suppliers. The process conditions to combine the carded and spunmelt web are shown in FIG. 6. A detailed description of the process conditions for Sample #9 shown in FIG. 6 will not be repeated as they correspond to those of Sample #1 in Example 5 above but with different values for the respective parameters. The resulting fabric has approximately 50% cotton content, with very good tensile strength of GMT=6.65 N/cm and excellent abrasion resistance of 4.0 visual rating as shown in FIG. 7. Additionally the average HOM data of 5.28 grams indicates excellent hand feel and fabric flexibility. In general, HOM is a measure of softness and lower the test value in grams, higher the softness.

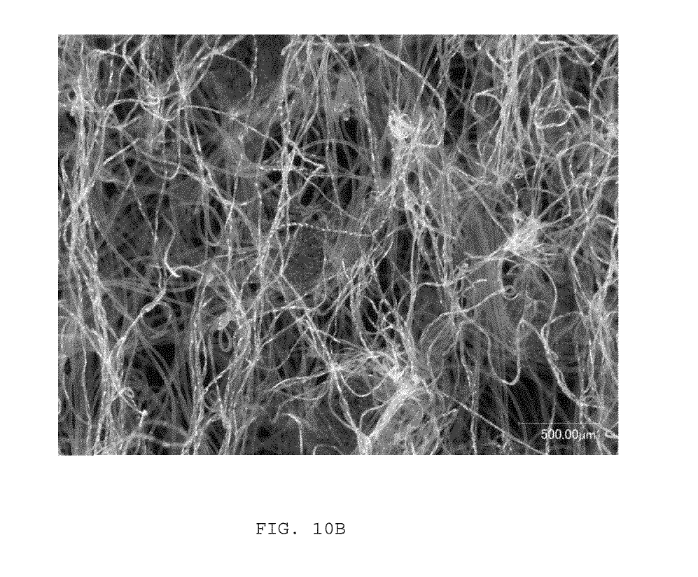

FIGS. 10A and 10B are micrographs of a Sample #9 composite fabric, FIG. 10B being a higher magnification micrograph.

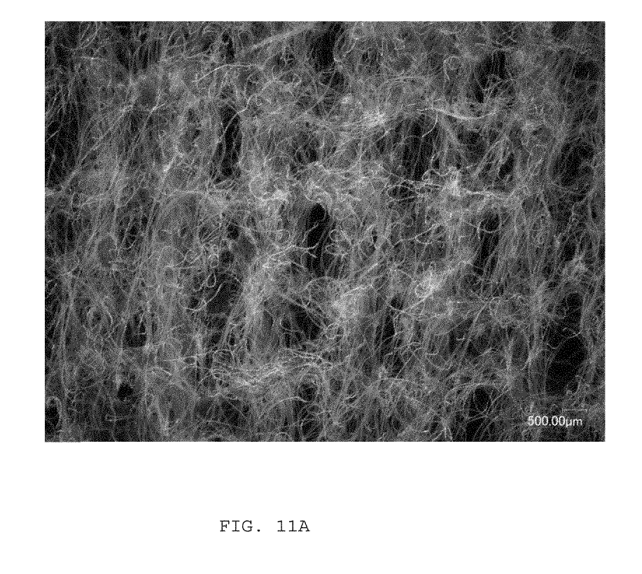

FIGS. 11A and 11B are micrographs of a Sample #10 composite fabric. FIG. 11B being a higher magnification micrograph. As shown in FIGS. 11A and 11B, a pattern in the composite fabric can be discerned resulting from a water injection step over an apertured screen AS1, as reflected in the Table of FIG. 6.

### Example 10: Method to Produce a Cotton Containing Nonwoven Fabric with Adjustable Wettability Characteristics

It is observed from FIG. 7 that the wettability characteristics can be varied significantly by changing the cotton fiber choice, blend proportion, basis weight, patterning effects, etc. More specifically, the fiber choice is very important for topsheet wettability characteristics, which is monitored in terms of strike through and rewet properties. Higher water strike-through and lower rewet properties indicate that the fabric is hydrophobic, while lower strike through and higher rewet properties indicate the fabric is hydrophilic. As shown in FIG. 7, the strike through properties range from 1.8 seconds to greater than 100 seconds, while the rewet properties ranges from 0.06 grams to 2.27 grams. Additionally the wettability characteristics can be changed further by treating the composite web with small amounts of topical philic surfactants. Sample #8, which had high strike through >100 seconds was modified with a small amount of topical philic surfactant and the resulting treated fabric had a strike through of 0.5 seconds with little to no effect on the rewet properties.

FIGS. 8A and 8B show physical testing data of competitive products available in the market for benchmarking a composite fabric made in accordance with an exemplary embodiment of the invention for both diaper topsheet and backsheet applications. The Goon product is believed to be produced using carded through air bonded (TABW) technology and apparently does not contain any cotton. Production technology for the “Natural Moony” product is unknown—it is believed to be a carding-based technology combined with either hydroentangling or through air bonding. The “Natural Moony” topsheet obtained from the diaper is believed to contain cotton fibers and is likely in the 5 to 15% cotton content range. The Goon product data listed in the table in FIG. 8A is from the diaper backsheet, which was carefully removed from the diaper to test for physical properties. In the case of “Natural Moony,” the data listed on the table in FIG. 8A is from the diaper “topsheet,” which was carefully removed from the diaper to test for physical properties. As seen from FIGS. 8A and 8B, it can be inferred that the typical GMT strength of such products are at or below 3 N/cm.

### Example 11

A composite fabric was produced by hydroentangling two webs together, with one web being a 13.5 gsm polypropylene spunmelt medium bonded nonwoven fabric, and the other web being a 15 gsm carded web comprising 50% staple polyester fiber, 30% hydrophobic cotton fiber and 20% PE/PP bico staple fiber. The spunmelt material was produced with 2% erucamide to provide softness and slickness. The composite fabric had at least 15% cotton in the final composition.

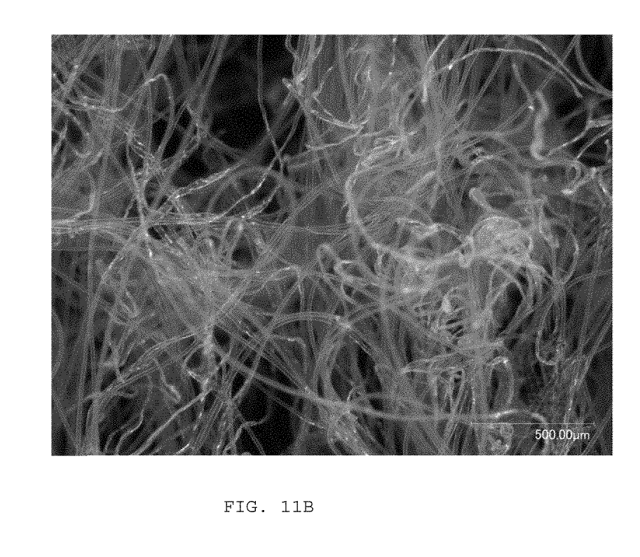

The product in this Example was made using the process described with reference to FIG. 12. Specifically, FIG. 12 illustrates a hydroentangling apparatus according to another exemplary embodiment of the present invention. A natural fiber web may be formed by a carding machine (or “unit”) and a spunmelt web may be unwound before being fed to the hydroentangling apparatus where the webs are layered together, subjected to pre-wetting (Pre-inj) at a pressure within a range of 10 to 30 bar and subsequently fed to drums (Drum 1, Drum 2, and Drum 3) with respective water injectors (Inj 1, Inj 2, and Inj 3). Each of the injector manifolds in Drum 1 have a pressure range of 40 to 100 bar, while each of the injector manifolds in Drums 2 and 3 have a pressure range of 80 to 180 bar. The hydroentangled web layers may then be dried to form the composite product.

In this Example, a 13.5 gsm polypropylene spunmelt medium bonded nonwoven fabric produced using Reicofil technology was unwound on an Andritz spunlace line. 15 gsm carded web produced in line using Andritz spunlace technology was laid on top of the unwound spunmelt web and hydro-entangled together. The 15 gsm carded web contained discontinuous staple fibers having of at least 30% hydrophobic cotton fiber, 50% polyester fiber and 20% PE/PP bico fiber. The polyester fiber was a standard staple fiber with 1.5 to 2 denier per filament, 38 mm fiber length and was commercially available through several polyester fiber suppliers. Fiber length of hydrophobic cotton fiber was typically in the range of 20 mm to 25 mm and was purchased from several cotton suppliers. Bico PE/PP fiber used in this example had a dTex of ˜1.75, with a staple fiber length of 38 mm and was commercially purchased through various bico fiber manufacturers. The two-layered structure made up of the carded web and spunmelt web was introduced into the jet lace unit and was hydroentangled with a combined energy flux of ˜0.20 to 0.35 kwh/kg. The resultant fabric was subsequently dried and wound into a roll. This composite product was tested to have a GMT of greater than 5 N/cm. All other physical parameters are shown in Table 1 below (six different sets of measurements were taken, with each labeled 11A-11F, respectively).

TABLE 1

| | | | | ASTM Tensiles | | | | | Handle-O-Meter | |
|---|---|---|---|---|---|---|---|---|---|---|
| | | Air Perm | Thickness | MDT | CDT | | GMT, | Abrasion | MD | CD |
| Example | BW (gsm) | (cfm) | (mm) | (N/cm) | (N/cm) | CDE (%) | (N/cm) | Visual | (grams) | (grams) |
| 11A | 30.5 | 584 | 0.36 | 14.7 | 4.5 | 114.0 | 8.1 | 5.0 | 10.4 | 3.9 |
| 11B | 29.6 | 600 | 0.34 | 14.8 | 4.1 | 124.6 | 7.8 | 4.2 | 6.5 | 2.1 |
| 11C | 29.2 | 640 | 0.38 | 14.3 | 3.9 | 110.7 | 7.5 | 4.0 | 7.1 | 2.1 |
| 11D | 29.7 | 627 | 0.40 | 16.5 | 4.1 | 111.2 | 8.2 | 4.2 | 9.7 | 2.5 |
| 11E | 29.4 | 789 | 0.42 | 16 | 4.0 | 109.9 | 8.0 | 4.2 | 7.3 | 1.9 |
| 11F | 29.2 | 653 | 0.45 | 14.6 | 3.8 | 108.9 | 7.4 | 4.1 | 6.5 | 1.1 |

### Comparative Example 1

Sample 7 shown in FIGS. 6 and 7 was normalized to 25 gsm basis weight for comparative purposes. The resultant Sample 7 normalized data is shown in FIG. 8B along with competitive topsheet data obtained from cotton containing “Natural Moony” product. As shown in FIG. 8B, it is observed that the Sample 7 “normalized” has significantly higher GMT strength of 4.7 N/cm versus 3.0 N/cm at comparable CD HOM values. This higher strength similar to other examples explained before leads to superior fiber tie-down and therefore very good to excellent abrasion properties.

According to an exemplary embodiment, the composite fabric exhibit a two-sidedness characteristic in that the surface characteristics of one surface are different from those of the other surface. In a more specific exemplary embodiment, the amount of fibers protruding from one surface of the fabric is different from the amount of fibers protruding from the other surface. Without being bound by theory, it is believed that this phenomena is due to the short staple fibers from the carded web protruding preferentially to the carded side rather than the spunmelt side. As a result of this differential, the material displays a two sidedness that may be perceived as softness to the touch.

The amount of fibers protruding from a fibrous material may be measured using the “Fuzz on Edge Test Method” as discussed in U.S. Pat. No. 8,679,295, the contents of which are incorporated herein by reference in their entirety. This test is described below.

Fuzz on Edge Test Method

The Fuzz on Edge methodology measures the amount of fibers that protrude from the surface of a fibrous material. The measurement is performed using image analysis to detect and then measure the total perimeter of protruding surface fibers observed when the material in question is wrapped over an “edge” to allow the fibers to be viewed from the side using transmitted light. An image analysis algorithm was developed to detect and measure the perimeter length (mm) of the fibers per edge length (mm) of material, where the perimeter length is defined as the total length of the boundaries of all of the protruding fibers (i.e. Perimeter/Edge Length or PR/EL for short). For example, an edge along the majority of the length of a fibrous material (e.g. facial tissue) can be measured by acquiring and analyzing multiple, adjacent fields-of-view to arrive at a single PR/EL value. Typically, several such material specimens are analyzed for a sample to arrive at a mean PR/EL value. In the specific test method used, measurements were taken for seven regions of the same sample and then averaged to obtain the FOE value for the material. The material in this case was the composite fabric of Example 11. FOE measurements were taken using a Leica DMS1000 digital microscope, a Leica MDG41 computer controlled motorized stage and base, and an algorithm written by Vashaw Scientific, Inc. (11660 Alpharetta Highway Suite 155, Roswell, Ga. 30076).

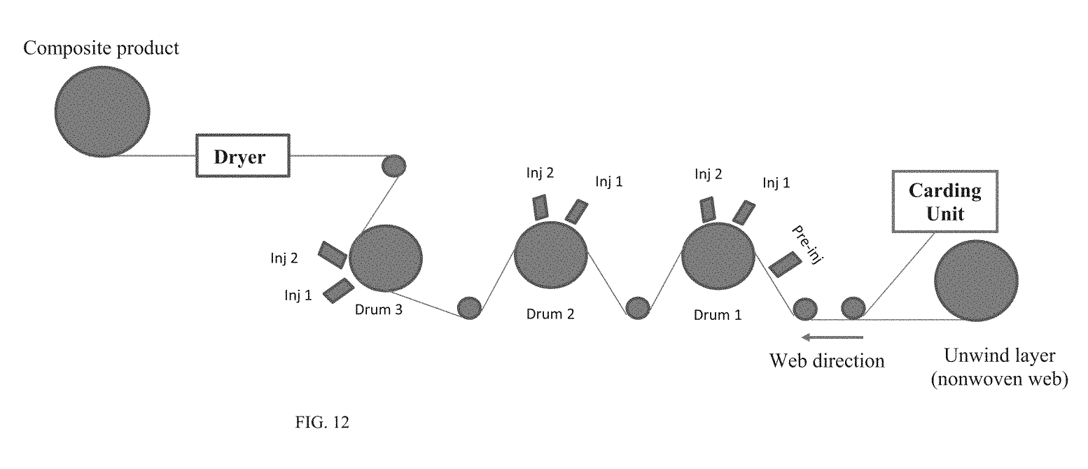

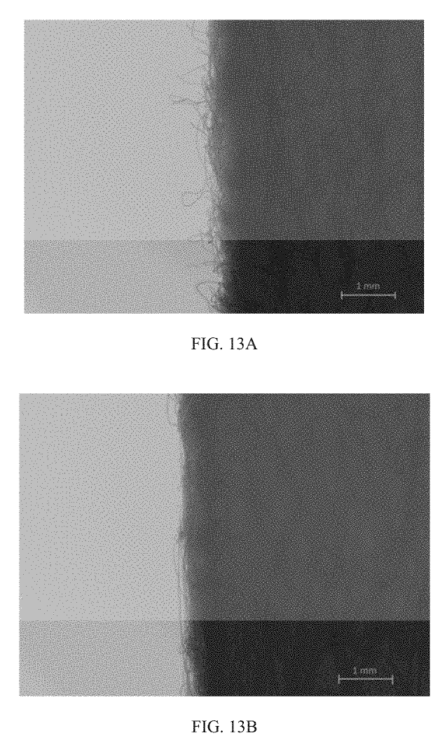

Table 2 below shows the results of three different trials of a Fuzz on Edge test performed on the samples described with reference to Example 11. In Table 2, “Side A” refers to the carded side and “Side B” refers to the spunmelt side, and the difference in FOE between the two sides is reported as “FOE Differential.” FIG. 13A is a micrograph showing the carded side surface of the composite web and FIG. 13B is a micrograph showing the spunmelt side surface of the composite web. Based on results shown in Table 2, FOE value of the carded side is consistently greater than the FOE value of the spunmelt side, with an FOE differential of >0.2 consistently observed.

TABLE 2

| # | Side A (Carded side) | Side B (Spunmelt side) | FOE Differential |
|---|---|---|---|
| 1 | 2.35 | 1.89 | 0.46 |
| 2 | 2.78 | 2.27 | 0.51 |
| 3 | 2.89 | 1.71 | 1.18 |

While in the foregoing specification a detailed description of specific embodiments of the invention was set forth, it will be understood that many of the details herein given may be varied considerably by those skilled in the art without departing from the spirit and scope of the invention.

1. A composite fabric comprising:
a polypropylene spunmelt medium bonded nonwoven web, the nonwoven fabric having a basis weight of 8 gsm to 40 gsm; and
a carded nonwoven web comprising 40 wt % to 70 wt % staple polyester fibers, 5 wt % to 50 wt % hydrophobic cotton fibers and 5 wt % to 50 wt % polyethylene-polypropylene bicomponent fibers, the carded nonwoven web having a basis weight of 7 gsm to 50 gsm, the nonwoven web being bonded with the carded nonwoven web by hydroentanglement.

2. The composite fabric of claim 1, wherein the spunmelt nonwoven web comprises a slip additive in an amount of 0.1 wt % to 2 wt %.

3. The composite fabric of claim 1, wherein the composite fabric contains cotton in an amount of at least 5 wt %.

4. The composite fabric of claim 1, wherein the composite fabric contains spunmelt fiber in an amount of 20 wt % to 80 wt %.

5. The composite fabric of claim 1, wherein the composite fabric contains polyethylene-polypropylene bicomponent fibers in an amount of at least 5 wt %.

6. The composite fabric of claim 1, wherein the composite fabric contains polyester fiber in an amount of at least 20 wt %.

7. The composite fabric of claim 1, wherein the composite fabric has a basis weight within the range of 25 gsm to 32 gsm.

8. The composite fabric of claim 1, wherein the composite fabric has a roughness with a skew value (Ssk) that is less than zero as measured using a Keyence VR-3000 G2 3D microscope.

9. The composite fabric of claim 1, wherein the composite fabric has an air permeability greater than 400 cfm.

10. The composite fabric of claim 1, wherein the composite fabric has a thickness within the range of 0.25 mm to 0.60 mm.

11. The composite fabric of claim 1, wherein the composite fabric has a machine direction tensile strength greater than 5.5 N/cm.

12. The composite fabric of claim 1, wherein the composite fabric has a cross direction tensile strength greater than 1.5 N/cm.

13. The composite fabric of claim 1, wherein the composite fabric has a cross direction elongation greater than 80%.

14. The composite fabric of claim 1, wherein the composite fabric has a geometric mean tensile strength greater than 3.1 N/cm.

15. The composite fabric of claim 1, wherein the composite fabric has an abrasion rating greater than 3.0 as measured in accordance with ASTM D 4966-98 standard.

16. The composite fabric of claim 1, wherein the composite fabric has a machine direction Handle-O-Meter (HOM) stiffness within the range of 5.0 grams to 12.0 grams.

17. The composite fabric of claim 1, wherein the composite fabric has a cross direction Handle-O-Meter (HOM) stiffness within the range of 1.0 grams to 5.0 grams.

18. The composite fabric of claim 1, wherein the composite fabric has a two-sidedness with a Fuzz on Edge (FOE) differential value of 0.2 or greater.

19. A method of forming a composite fabric, comprising:
forming a polypropylene spunmelt medium bonded nonwoven web, the nonwoven fabric having a basis weight of 8 gsm to 40 gsm;
forming a carded nonwoven web comprising 40 wt % to 70 wt % staple polyester fibers, 5 wt % to 50 wt % hydrophobic cotton fibers and 5 wt % to 50 wt % polyethylene-polypropylene bicomponent fibers, the carded nonwoven web having a basis weight of 7 gsm to 50 gsm; and
hydroentangling the nonwoven web with the carded nonwoven web.

20. The method of claim 19, wherein the hydroentangling step comprises a plurality of hydroentangling steps.

21. The method of claim 19, wherein the plurality of hydroentangling steps comprise at least two water injection steps.

22. The method of claim 19, wherein the plurality of hydroentangling steps comprise:
a first water injection step of exposing the webs to a plurality of water jets at a first pressure range of 40-120 bars;
a second water injection step of exposing the webs to a plurality of water jets at a second pressure range of 60-150 bars; and
a third water injection step of exposing the webs to a plurality of water jets at a third pressure range of 60-250 bars.

23. The method of claim 19, wherein the spunmelt nonwoven web is thermally bonded by an engraved roll, at a temperature range of 120 to 170° C., and a smooth roll, at a temperature range of 120 to 170° C., having a calender nip pressure range of 20 to 150 N/mm.
